(19) United States
(12) Patent Application Publication
(10) Pub. No.: US 2017/0206328 A1
(43) Pub. Date: Jul. 20, 2017

(54) HEALTHCARE SERVER, HEALTHCARE SERVER CONTROL METHOD, AND NON-TRANSITORY COMPUTER READABLE MEDIUM

(71) Applicant: FiNC Co. Ltd., Tokyo (JP)

(72) Inventors: Yuji MIZOGUCHI, Tokyo (JP); Mitsunori NANNO, Tokyo (JP); Rei SAKAMOTO, Tokyo (JP)

(73) Assignee: FiNC Co. Ltd., Tokyo (JP)

(21) Appl. No.: 15/102,427

(22) PCT Filed: Jul. 31, 2015
(86) PCT No.: PCT/JP2015/071808

§ 371 Date: Jun. 7, 2016

(51) Int. Cl. G06F 19/00; G06F 17/27

(52) U.S. Cl. CPC G06F 19/3418; G06F 17/273; G06F 17/2785

(57) ABSTRACT

A healthcare server connected to a terminal over a network includes a storage unit that stores healthcare target information of a healthcare target having the terminal, question information, and answer information, a reception unit that receives image information or message information transmitted from the terminal, an analysis unit that analyzes language information based on the received message information and acquires the question information from the analyzed language information, a generation unit that extracts the answer information corresponding to the acquired question information and generates a sentence example based on the extracted answer information, an evaluation unit that evaluates the extracted answer information with a degree of confidence indicating the certainty of the answer information, a correction unit that corrects the sentence example and the evaluation based on the healthcare target information, and a transmission unit that transmits the corrected sentence example and evaluation to the terminal.

### TECHNICAL FIELD

The present invention relates to a healthcare server, a healthcare server control method, and a non-transitory computer readable medium and, particularly, to a healthcare server, a healthcare server control method, and a non-transitory computer readable medium storing a healthcare program that analyze language information.

### BACKGROUND ART

In recent years, with the increase of health consciousness such as diets or the prevention of metabolic syndrome, health guidance services with the aid of experts have become widespread. Furthermore, with the use of IT, cases in which a client receives health guidance service on-line without the expert and the client directly meeting face-to-face have increased.

In such a health guidance service, the expert needs to check taken meals, current health state, and the preferences of the client from an online terminal, create a message for guidance based on the check result, and send a message to the online terminal of the client.

As a technology for creation and transmission of such a message, for example, PTL 1 describes a technology in which a database server device receives biological information from a patient and generates a template message for healthcare guidance corresponding to the received biological information in order for a doctor to send a message for healthcare advice to the patient remotely. Furthermore, PTL 1 discloses that the doctor is able to receive the generated template message and edit the template message as an advice message.

PTL 2 describes a technology in which a pointing device establishes a feedback unit that graphically presents, to a user, any one of the measured biological signals, portions of pattern characteristics, outputs of a neutral net, results of movement direction forecasting, and the amount of movement as the processing status of each unit during point control.

### CITATION LIST

### Patent Literature

[PTL 1] JP-A-2004-321373

[PTL 2] JP-A-2005-011037

### SUMMARY OF INVENTION

### Technical Problem

However, in the invention described in PTL 1, the database server device generates the template message for healthcare advice corresponding to biological information. Accordingly, the doctor does not need to compose the advice message for each patient from scratch, thus achieving standardization and efficiency. However, since the template message is generated from a pre-stored message sentence, the need to create and store variations of the template message sentence leads to a loss in efficiency. Furthermore, a database device cannot flexibly generate template messages most suitable for the patient according to, for example, characteristics of the biological information of each patient and a change in the biological information.

The invention described in PTL 2 makes possible an improvement of the accuracy of the trend estimation, a decrease in tracking error, and improvement of operability through feedback to the user. However, there is a problem in that the feedback does not contribute to improvement of the accuracy of the pointing device itself at all, and usability of the pointing device itself does not change.

Therefore, the present invention has been made in view of the above problem, with the objective to create a server capable of achieving standardization and efficiency in the creation of expert advice messages from biological information, diet, health state or other information from a client at the time the message for guidance is created and transmitted, as well as being capable of providing advice most relevant to the health state at that time of the client who is a target. In addition, the accuracy of the health guidance service is to be improved through feedback.

### Solution to Problem

The healthcare server referred to in the present invention is a healthcare server connected to a terminal over a network, and includes a storage unit that stores healthcare target information of a healthcare target having the terminal, question information and answer information; a reception unit that receives image information or message information transmitted from the terminal; an analysis unit that analyzes language information based on the received message information and acquires the question information from the analyzed language information; a generation unit that extracts the answer information corresponding to the acquired question information and generates a sentence example based on the extracted answer information; an evaluation unit that evaluates the extracted answer information with a degree of confidence indicating the certainty of the answer information; a correction unit that corrects the sentence example and the evaluation based on the healthcare target information; and a transmission unit that transmits the corrected sentence example and evaluation to the terminal.

Furthermore, the healthcare server described in the present invention may be connected to the terminal over the network, and the corrected sentence example and evaluation are displayed on and output to a display unit of the terminal.

Furthermore, in the healthcare server described in the present invention, the transmission unit may transmit advice information including a sentence example and an evaluation selected or selected and edited on the display unit by an expert to the terminal.

Further, in the healthcare server according to the invention, the evaluation unit may determine whether the degree of confidence of the evaluation is higher or lower than a certain level, and select either correction of the sentence example or generation of an alert message and notification of the alert message to the expert, based on a result of the determination, the correction unit may correct the sentence example based on the determination result and the answer information for avoidance in a case in which the evaluation unit selects the correction of the sentence example, and the transmission unit may notify a terminal of the expert of the alert message in a case in which the evaluation unit selects the notification of the alert message to the expert.

Further, in the healthcare server according to the invention, the reception unit may receive sentence example selection information of the expert, and behavior selection information, behavior execution information and biological log information of the healthcare target from the terminal, and the evaluation unit may perform a combination based on the sentence example selection information, the behavior selection information, the behavior execution information, and the biological log information that have been received or a time stamp of the information, and evaluate answer information associated with the sentence example selection information, the behavior selection information, the behavior execution information, and the biological log information that have been combined.

Further, in the healthcare server according to the invention, the image information may be captured by the terminal, and the analysis unit may calculate a feature of the captured image information, and analyze language information based on the feature and the question information.

Further, the healthcare server according to the invention may further include a calculation unit that calculates a use frequency of answer information of each healthcare target, the storage unit may store a past use history and a past use frequency of the answer information of the healthcare target, as use history information, and the correction unit may correct the sentence example based on the use history information.

Further, in the healthcare server according to the invention, the reception unit may receive image information or message information transmitted from a plurality of terminals grouped in advance, the evaluation unit may specify a terminal in the group transmitting a sentence example that is the same as, similar to, or opposite to a sentence example transmitted to the terminal within a predetermined time, and determine a healthcare target holding the specified terminal as a comparison target, and the correction unit may also correct the sentence example and the evaluation based on information on the comparison target.

A control method for a healthcare server according to the present invention is a control method for a healthcare server connected to a terminal over a network, and includes storing healthcare target information of a healthcare target having the terminal, question information, and answer information; receiving image information or message information transmitted from the terminal; analyzing language information based on the received message information, and acquiring the question information from the analyzed language information; extracting the answer information corresponding to the acquired question information and generating a sentence example based on the extracted answer information; evaluating the extracted answer information with a degree of confidence indicating the certainty of the answer information; correcting the sentence example and the evaluation based on the healthcare target information; and transmitting the corrected sentence example and evaluation to the terminal.

A non-transitory computer readable medium according to the present invention is a non-transitory computer readable medium storing a healthcare program causing a computer to execute control of a healthcare server connected to a terminal over a network, the healthcare program comprising: storing healthcare target information of a healthcare target having the terminal, question information, and answer information; receiving image information or message information transmitted from the terminal; analyzing language information based on the received message information, and acquiring the question information from the analyzed language information; extracting the answer information corresponding to the acquired question information and generating a sentence example based on the extracted answer information; evaluating the extracted answer information with a degree of confidence indicating the certainty of the answer information; correcting the sentence example and the evaluation based on the healthcare target information; and transmitting the corrected sentence example and evaluation to the terminal.

### Advantageous Effects of Invention

In the healthcare server, the healthcare server control method, and the healthcare program according to the present invention, when the expert creates the advice message, a sentence example which becomes an answer to a query from a client (healthcare target) or the expert can be generated based on accumulated best practices, the generated sentence example can be customized with characteristics of the client (biological information, diet, and health state at that time), and the resultant sentence example can be transmitted to the expert. Thus, in the advice message creation and transmission by the expert, it is possible to achieve standardization and efficiency and perform guidance further fitted to the client.

Further, in the healthcare server, the healthcare server control method, and the healthcare program according to the present invention, since learning can be performed through feedback of results of the advice selection and execution of the client and a change in a living body, it is possible to provide the health guidance service of which the improvement of accuracy is automatically achieved.

### BRIEF DESCRIPTION OF DRAWINGS

FIG. 1 is a system diagram illustrating a system configuration of a healthcare system.

FIG. 2 is a block diagram illustrating a functional configuration of a healthcare server and a terminal.

FIG. 3 is a schematic diagram illustrating interaction between a healthcare target and a healthcare server or an expert.

FIG. 4 is a schematic diagram illustrating feedback to the healthcare server.

FIG. 5 is a schematic diagram illustrating an example of a combination of behavior selection information, behavior execution information, and biological log information.

FIG. 6 is a data conceptual diagram illustrating an example of a data structure of healthcare target information and learning information.

FIGS. 7A to 7D are schematic diagrams illustrating a correction example of an evaluation of answer information.

FIGS. 8A to 8F are schematic diagrams illustrating an example of a relationship among message information, language information, question information, answer information, and a sentence example.

FIG. 9 is a flowchart illustrating an operation of a server.

FIG. 10 is a schematic diagram illustrating an example of a genetic test algorithm.

FIG. 11 is a schematic diagram illustrating an example of a blood test algorithm.

FIG. 12 is a schematic diagram illustrating an example of a content distribution algorithm.

### DESCRIPTION OF EMBODIMENTS

Hereinafter, an embodiment of the present invention will be described with reference to the drawings.

### SUMMARY

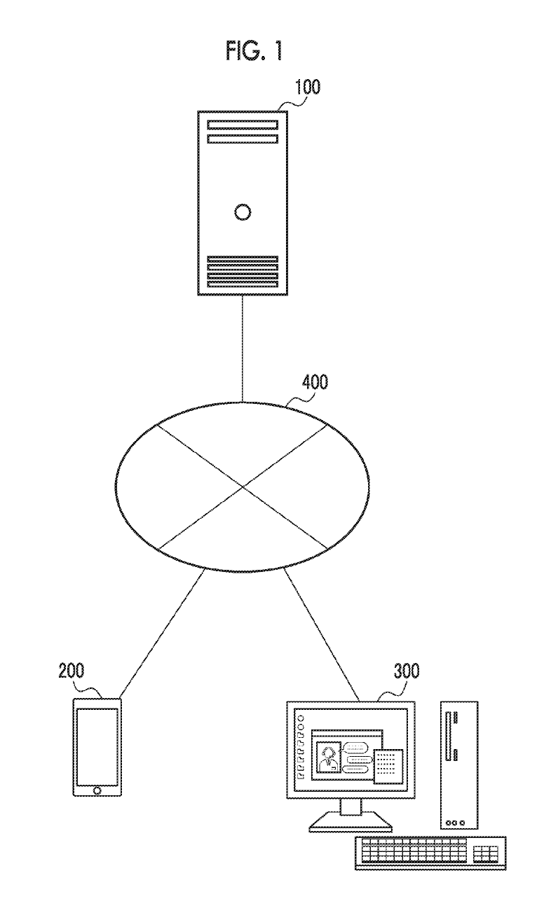

FIG. 1 is a system diagram illustrating a system configuration of a healthcare system.

As illustrated in FIG. 1, the healthcare system includes a healthcare server 100, and a plurality of user terminals 200 and 300. The healthcare server 100 is connected to the user terminal 200 and the user terminal 300 over a network 400. In FIG. 1, for simplification of description, only two user terminals are illustrated, but it is understood that there may be more user terminals. Further, specific devices of both of the user terminal 200 and the user terminal 300 are not limited to a portable terminal and a personal computer as illustrated in FIG. 1 and may be, for example, a smartphone, a tablet terminal, a personal computer, or another electronic device. Further, the specific device of the user terminal 200 may be a wearable device. The wearable device includes a device that measures a heart rate, a pulse, a blood pressure, the number of steps, the amount of activity, a posture, a position, a movement, and position information of the healthcare target.

Here, it is assumed that, for example, the user terminal 200 indicates a terminal owned by a healthcare target, and the user terminal 300 indicates a terminal owned by an expert. A question message for inquiring about a meal to be currently taken by the healthcare target is transmitted to the healthcare server 100.

If the server 100 receives a question message, the server 100 analyzes the question message, generates a sentence example from answer information corresponding thereto, and performs evaluation on the answer information. The sentence example and the evaluation are transmitted as they are as an advice message to the user terminal 200 or displayed on and output to the user terminal 300. In the latter case, the expert selects the sentence example to be transmitted to the healthcare target from the displayed and output sentence example and evaluation, and edits the sentence example, if necessary. The server 100 transmits the sentence example and the evaluation selected or edited by the expert as an advice message to the user terminal 300.

Accordingly, the server 100 transmits the advice message or the advice message selected and edited in the user terminal 300 by the expert to the user terminal 200 via the server 100 to perform the guidance for healthcare on the healthcare target. The guidance may be performed individually for each healthcare target, or healthcare targets may be grouped and the guidance may be performed in units of groups. Here, the grouping is grouping for performing group guidance on a plurality of healthcare targets.

<Configuration>

Hereinafter, configurations of the server 100, the user terminal 200, and the user terminal 300 will be described.

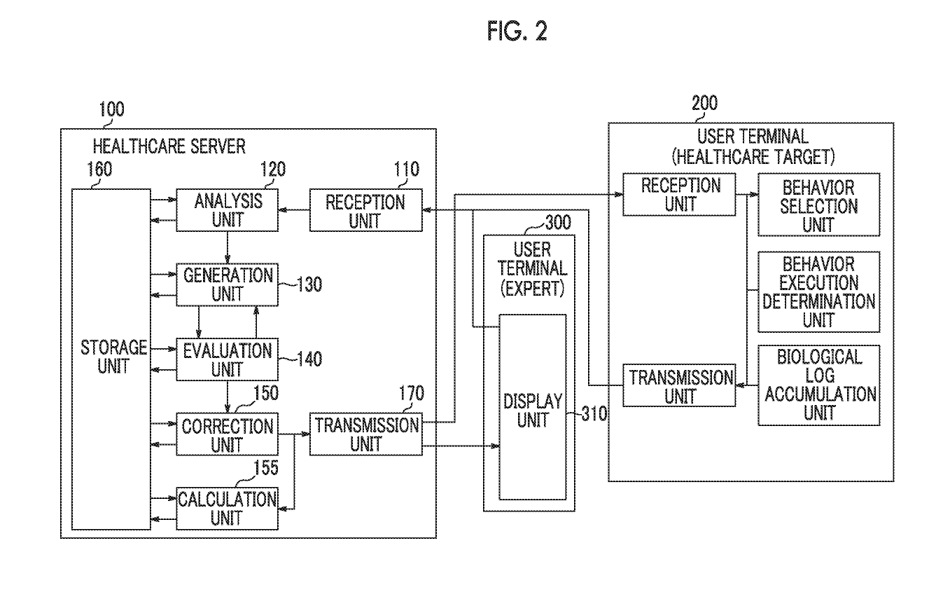

FIG. 2 is a block diagram illustrating functional configurations of the server 100, the user terminal 200 and the user terminal 300.

As illustrated in FIG. 2, the server 100 includes a reception unit 110, an analysis unit 120, a generation unit 130, an evaluation unit 140, a correction unit 150, a storage unit 160, and a transmission unit 170.

The reception unit 110 receives image information and message information transmitted from the user terminal 200 or the user terminal 300 over the network 400. Communication in the transmission and the reception may be either wired communication or wireless communication, and if mutual communication can be performed, any communication protocol may be used.

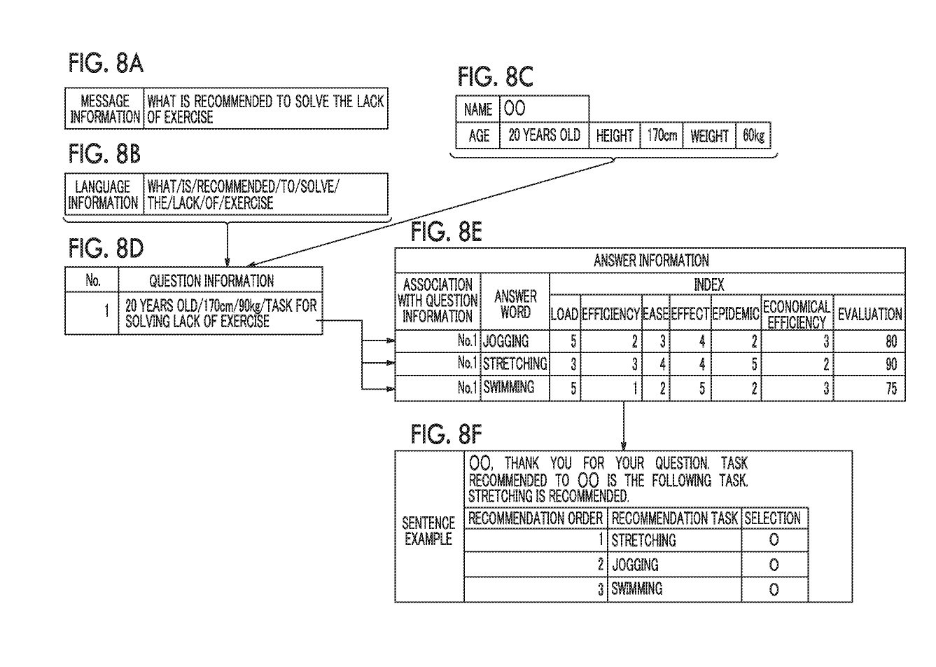

The analysis unit 120 has a function of analyzing language information from the message information transmitted from the user terminal 200 or the user terminal 300 based on question information stored in the storage unit 160, and searching for and acquiring relevant question information using the analyzed language information, or the analyzed language information and healthcare target information of a healthcare target who is a target as a key. Here, the analysis of the language information refers to, specifically, conversion of a sentence of the message information into a more formal representation. For example, the analysis may be performed using a natural language processing technique, such as morphological analysis and syntax analysis. Here, the question information refers to input information for deriving answer information from the language information, which is a set of, for example, words decomposed into formal elements that can be recognized by a computer, as illustrated in FIGS. 8A to 8F.

Further, the analysis unit 120 has a function of calculating features of the image information as well as the message information received by the reception unit 110 and analyzing the language information based on the calculated features, the question information, and the healthcare target information.

Further, the analysis unit 120 has a function of analyzing the feature of a living body from biological information and biological log information of the healthcare target to calculate a feature value of the living body. Here, the feature value of the living body and a tendency value of a behavior refer to, for example, a value calculated through tendency estimation or the like from the biological information, the biological log information, and the behavior information, and a feature value of the living body or a tendency value of the behavior of a self-report heard in a lifestyle questionnaire. In the calculation, analysis schemes such as tendency estimation, factor analysis, correlation analysis, and statistical analysis may be used.

The generation unit 130 extracts the answer information which is a candidate of the sentence example using the language information analyzed by the analysis unit 120. Here, the answer information refers to association with the question information, answer content, and past evaluation of the answer information as best practices corresponding to the question information. Further, in the extraction, for example, a data mining scheme such as frequent pattern extraction and class classification may be used. A hypothesis is generated by inference from the extracted answer information, and verified by finding a ground supporting the hypothesis or a disproof denying the hypothesis from the question information and the answer information. In the inference, for example, deductive inference, inductive inference, probabilistic inference, or the like may be used. A plurality of extractions of the answer information that is a sentence example candidate, and generations and verifications of the hypothesis are performed at the same time in parallel processing. Results of the verification in the parallel processing are integrated to generate the sentence example.

The evaluation unit 140 evaluates a degree of confidence of the answer information which is a candidate of the sentence example extracted by the generation unit 130 based on a ground supporting a thing found by the generation unit 130 and previous evaluation of the answer information. Here, the degree of confidence refers to a degree indicating the certainty of the sentence example, refers to an index indicating a degree of importance of an association rule in data mining, or refers to a proportion of selection of corresponding answer information or occurrence of an action event when an event in which the question information is input occurs.

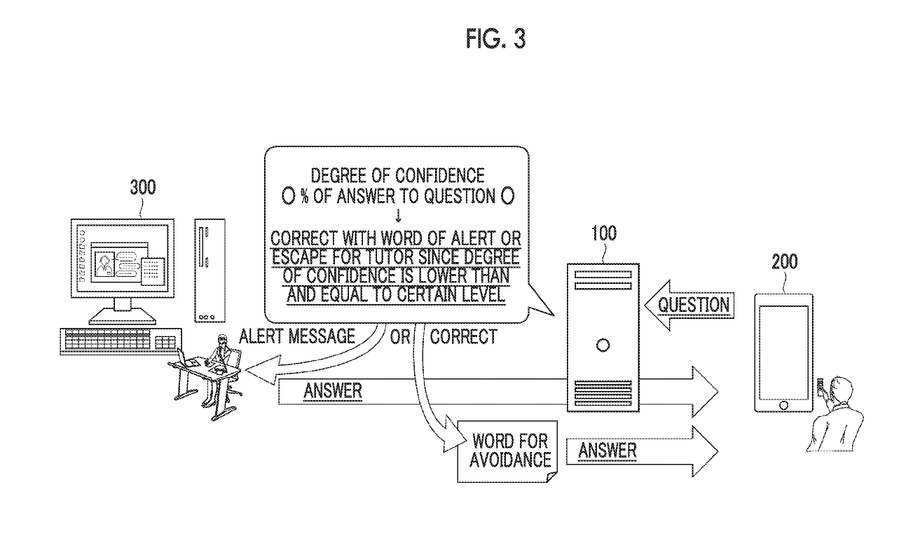

Further, the evaluation unit 140 determines whether the degree of confidence is higher or lower than a predetermined level, extracts answer information for avoidance from the answer information stored in the storage unit 160 in a case in which the evaluation unit 140 determines that the degree of confidence is lower than the predetermined level, and overwrites and corrects the sentence example so as to become the extracted answer information or transmits an alert message including the transmitted message information, the sentence example, and the evaluation to the user terminal 200 of the expert, as illustrated in FIG. 3.

Here, the answer information for avoidance refers to answer information including answer content indicating that the message content cannot be understood or an appropriate response cannot be found regardless of content of the transmitted message information. The answer information for avoidance refers to, for example, a message prepared in order to avoid an answer to the question, such as “I'm sorry. Since an appropriate answer to content of an inquiry is not found, I'm sorry to trouble you, but please contact us again by phone.” or “I'm sorry. Please indicate the content of the inquiry in as specific words as possible for accurate understanding of the content of the inquiry, and then, please contact us again.”

According to the healthcare server, the healthcare server control method, and the healthcare program of the present invention, it is possible to avoid transmission of message information of which the degree of confidence is lower than a certain level, for example, in which an incorrect answer to a question or inappropriate content is included, to the healthcare target, and to maintain high-accuracy of advice.

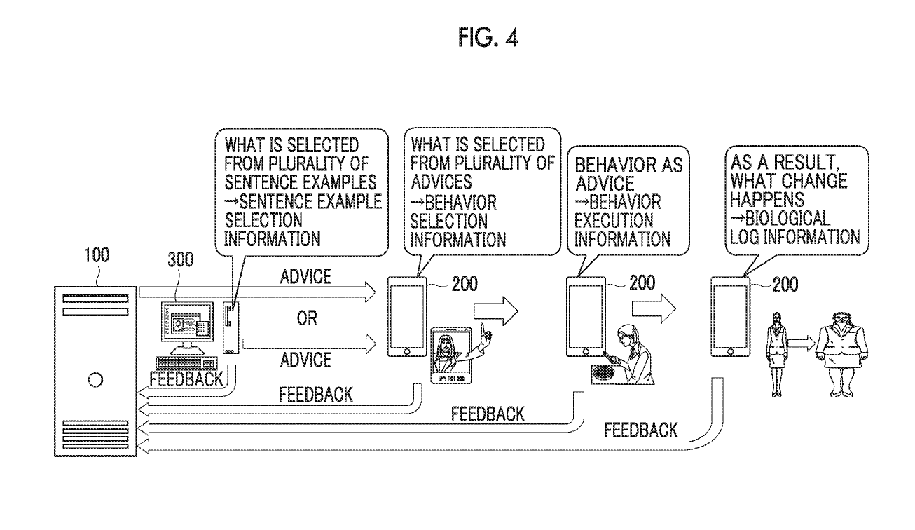

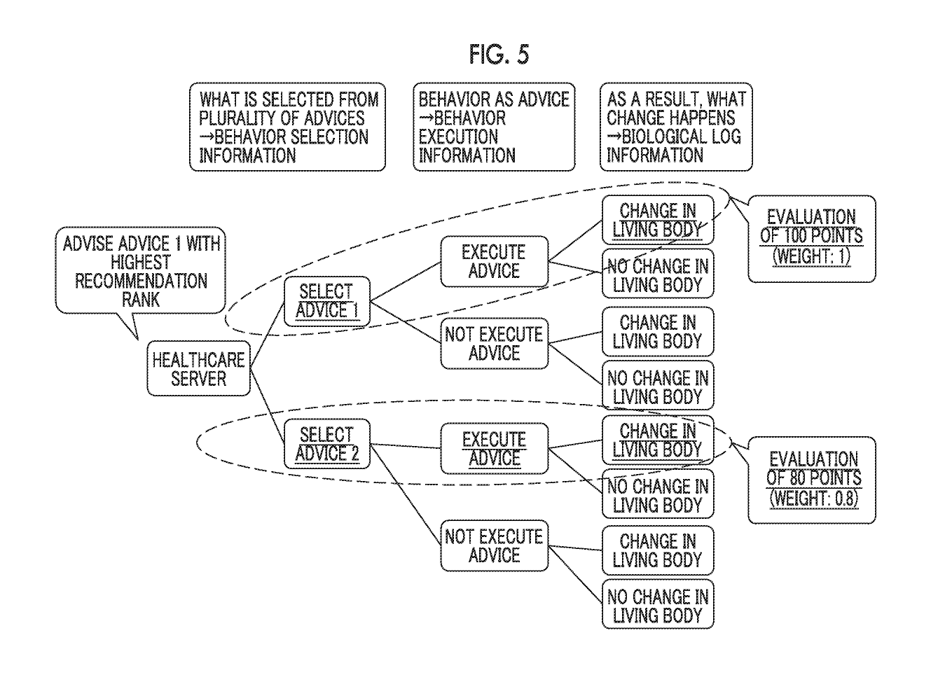

Further, the evaluation unit 140 evaluates the answer information based on the sentence example selection information of the expert that the reception unit 110 receives from the user terminal 300, and the behavior selection information, the behavior execution information and the biological log information of the healthcare target included in the message information and the image information received from the user terminal 200, as illustrated in FIG. 4. Specifically, the evaluation unit 140, for example, may perform combination based on, for example, the time stamp of the sentence example selection information, the behavior selection information, the behavior execution information, and the biological log information, and performs the evaluation based on the combination, as illustrated in FIG. 5. The evaluation unit 140 may perform the evaluation based on the information alone, as well as the combination.

The combination can be a combination of the behavior execution information and the biological log information holding the time stamp within a predetermined time based on, for example, the time stamp of the sentence example selection information and the behavior selection information corresponding to the sentence example selection information, for each expert and healthcare target. Here, the predetermined time may be set to any time of 15 minutes, 30 minutes, 1 hour, 3 hours, or 5 hours, or the like, but preferably set according to the lifestyle of diet or exercise. In this case, in a case in which relevant behavior information and biological log information cannot be received, this can be treated as no evaluation or negative evaluation.

For the answer information associated with the sentence example selection information, the behavior selection information, the behavior execution information, and the biological log information that have been combined, a fitness for purpose is set to be high and the evaluation is set to be high for the answer information in which the degree of confidence initially evaluated by the evaluation unit 140 is high, the advice is executed, or the living body changes toward a set target in curriculum information, and the fitness for purpose is set to be low and the evaluation is set to be low for the answer information in which the degree of confidence is low, the advice is not executed, or the living body does not change. Accordingly, the evaluation of the evaluation unit 140 can be fed back based on an objective fact.

For example, as illustrated in FIG. 5, in a case in which an advice of which a recommended rank, that is, the degree of confidence is the highest is selected, action is performed according to the advice, and as a result, a change in the living body toward the set target occurs, the evaluation may be fed back with weight 1 as an evaluation of 100 points. In a case in which an advice that is not the advice of which the degree of confidence is the highest is selected even though the action is performed according to the advice and, as a result, a change in the living body toward the set target occurs, the evaluation can be fed back with weight 0.8 as an evaluation of 80 points which is an evaluation that is lower than in the former. A pattern of a combination thereof and an evaluation value of the pattern may be set appropriately.

Further, in a case in which the user terminal 200 of the healthcare target is grouped, the evaluation unit 140 determines a healthcare target holding an identically grouped terminal to which, within a predetermined time, a sentence example that is the same as, similar to, or opposite to the sentence example transmitted to the user terminal 200 is transmitted, as a comparison target. Further, here, the comparison target refers to another healthcare target belonging to the same group, who is a healthcare target requiring the same or similar guidance for comparison as a rival or a healthcare target requiring a completely opposite guidance for comparison as a target person or a person who serves as an example of how not to behave. Specifically, the evaluation unit 140 determines another healthcare target to which the same, similar, or opposite sentence example is transmitted within a predetermined time, as a comparison target.

The correction unit 150 corrects a ranking based on the degree of confidence evaluated by the evaluation unit 140 with the healthcare target information, the comparison target information, and the like. Specifically, the correction refers to correcting the evaluation using a correction value based on, for example, the biological information, the behavior information and the biological log information of the healthcare target, the feature value of the living body, and the tendency value of the behavior, and performing re-ranking based on the evaluation after the correction, or correcting the sentence example based on the biological information, the behavior information, and the biological log information of the healthcare target, and the comparison target information. Details of the correction process are shown in <Flow of operation> which will be described below. Further, the healthcare target information is shown in <Data> which will be described below.

According to the healthcare server, the healthcare server control method, and the healthcare program of the present invention, the sentence example and the evaluation are corrected with the information on the healthcare target stored in the storage unit 160, and accordingly, a customized advice message can be automatically sent to each healthcare target according to, for example, an occasional state. Accordingly, it is possible to provide content (for example, a message) further fitted to the healthcare target.

A calculation unit 155 has a function of calculating a frequency of use of the above sentence example. Specifically, the calculation unit 155 performs count-up using selection of the sentence example which is a target by the expert as a trigger. Further, the calculation unit 155 may perform count-up of the frequency of use for each curriculum of healthcare of the healthcare target, and reset the frequency of use at a time at which the curriculum ends.

The storage unit 160 stores the healthcare target information, the question information, and the answer information. The storage unit 160 is typically realized by various recording media, such as a hard disc drive (HDD), a solid state drive (SSD), and a flash memory.

The transmission unit 170 transmits, as an advice message, the sentence example and the evaluation generated and corrected by the server 100 or the sentence example and the evaluation selected and edited by the expert to the user terminal 200. Further, the transmission unit 170 has a function of transmitting the sentence example and the evaluation generated and corrected by the server 100 to the user terminal 300. Communication in the transmission is the same as that in the reception unit 110.

Further, as illustrated in FIG. 2, the user terminal 300 includes a display unit 310.

The display unit 310 communicates with the healthcare server 100 over the network 400 and displays and outputs the sentence example and the evaluation received from the server 100.

Further, in a case in which the healthcare targets have been grouped, and in a case in which the comparison target has been determined, the display unit 310 displays and outputs information on the comparison target. Specifically, the display unit 310 displays and outputs the information as “Mr./Ms. ∘∘ is a current rival.”

Further, with the display and the output of the comparison target, the display unit 310 displays and outputs information on a specified sentence example when displaying and outputting the sentence example in a case in which the sentence example transmitted within a predetermined time to the comparison target is specified. Specifically, the display unit 310 displays and outputs the information as “Transmitted to the rival Mr./Ms. ∘∘” just under the sentence example which is a target.

The functional configurations of the healthcare server 100 and the user terminal 300 have been described above.

<Data>

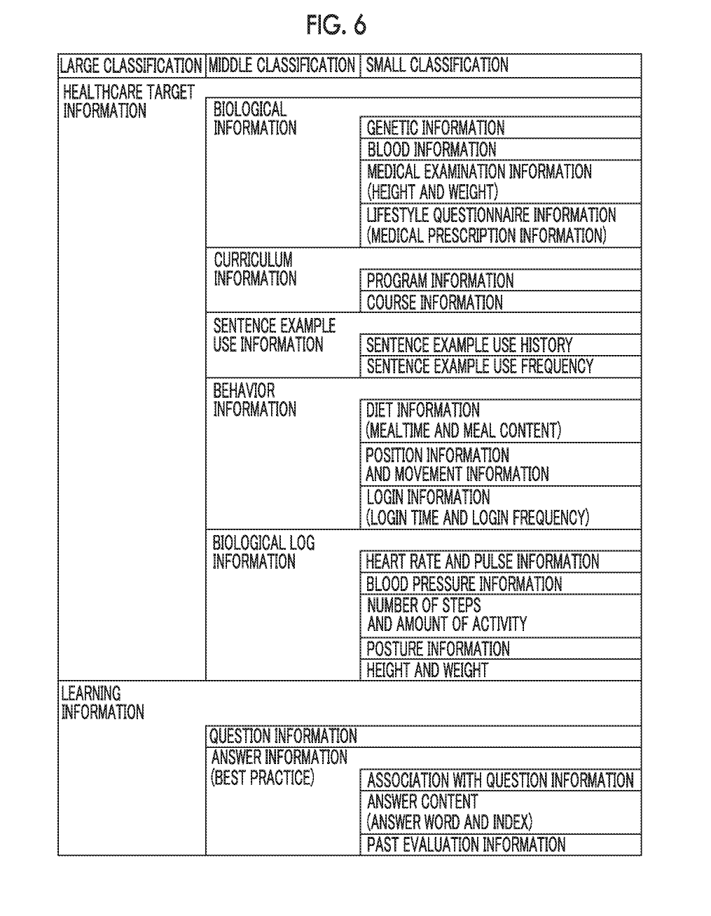

Here, in this embodiment, a data structure of the healthcare target information and learning information stored in the storage unit 160 is illustrated in FIG. 6.

FIG. 6 is a data conceptual diagram illustrating an example of the data structure of the healthcare target information and the learning information stored in the storage unit 160.

As illustrated in FIG. 6, the healthcare target information mainly includes biological information, curriculum information, sentence example use information, behavior information, and biological log information.

The biological information includes information on the healthcare target from both of an objective aspect and a subjective aspect of the healthcare target, such as genetic information, blood information, medical examination information (height and weight), and lifestyle questionnaire information of the healthcare target, and may include basic information and invariable information among information on the living body of the healthcare target.

The curriculum information includes program information selected by the healthcare target, course information in which one or more pieces of program information are combined, and set target information.

The sentence example use information includes a sentence example use history and a sentence example use frequency. Here, the use history information of the sentence example refers to either or both of a sentence example used in the past for each healthcare target, or/and last date and time on which the sentence example is last used for the healthcare target.

The behavior information includes diet information (mealtime and meal content), position information, movement information, and login information (login time and login frequency). The behavior information is information on the behavior in daily life of the healthcare target that is acquired by the user terminal 200. The behavior information may include text data or image data indicating content of the meal received from the user terminal 200 and a mealtime with a time stamp associated therewith, include movement information obtained from position information at that time obtained from the GPS data recorded in the user terminal 200, position information measured at any point of time, and position information measured at the next point of time, or include information such as a time of login for the service provided by the healthcare server 100 or a login frequency in a certain period of time (for example, a day, a week or a month). Further, the behavior information may include an access history of login obtained from the user terminal 200 or an information site of a login destination or a purchase history indicating that the healthcare target purchased health food such as a supplement, a health device, training machine, or the like. Further, the behavior information may include login information and logout information on the user terminal 200 that inform of selection or completion of a task on an application for healthcare such as diet.

The biological log information includes heart rate and pulse information, blood pressure information, the number of steps, the amount of activity, and posture information. The biological log information is information on a biological status of the healthcare target and a change in the biological status, and may include information obtained by a wearable device measuring and recording relevant biological log information in a case in which the user terminal 200 is the wearable device or a terminal cooperating with the wearable device. For example, the biological log information includes sleep (for example, REM sleep or non-REM sleep) information determined by sensing a movement of the healthcare target based on an acceleration sensor built into the user terminal 200.

As described above, the healthcare target information is not limited to biological information such as genetic information, blood information, and medical examination information of the healthcare target who is a target, curriculum information selected by the healthcare target, sentence example use information, behavior information acquired from the healthcare target, and attribute information such as medical prescription information. The healthcare target information is a concept including sleep state identification information obtained from the user terminal 200, in addition to the attribute information on the living body and the health provided by healthcare target. Further, the healthcare target information is a concept widely including information obtained from the user terminal 200 of the healthcare target, an information site of an login destination, or the like, such as health food such as a supplement, a health device, a purchase history of training machine or the like, log-in time, or a click through rate (CTR) of an advertisement and information web site.

According to the healthcare server, the healthcare server control method, and the healthcare program of the present invention, such information is stored in the storage unit 160, and learning can be performed by feeding back various information. Thus, it is possible to provide the healthcare target with timely content (for example, a message), and to provide a health guidance service of which the improvement of the accuracy is automatically achieved.

The question information of the user terminal 200 refers to input information for deriving answer information from the language information, which is a set of, for example, words decomposed into formal elements that can be recognized by a computer, as illustrated in FIGS. 8A to 8F.

The answer information is associated with the question information, and includes answer content (an answer word and an index), and past evaluation. The association with the question information may be association of the answer information with the question information and, for example, may be a number sequentially applied to the question information. The answer content includes the answer word and the index. The answer word is output information for a question and may include, for example, content of a recipe, fitness, a task, or a restaurant which becomes an answer to a consultation or a question or an advice to an inquiry. The index indicates a characteristic associated with the answer word, and may include, for example, a numerical value indicating characteristics such as a load, efficiency, ease, an effect, epidemic, and economical efficiency of a task included in the answer word. The past evaluation is a set of evaluations given to each piece of answer information so far and, specifically, may include, for example, statistics of the degree of confidence that the evaluation unit 140 has calculated so far. Further, the evaluation unit 140 calculates the degree of confidence based on the past evaluation.

<Operation>

An operation of the healthcare server 100 according to this embodiment will be described.

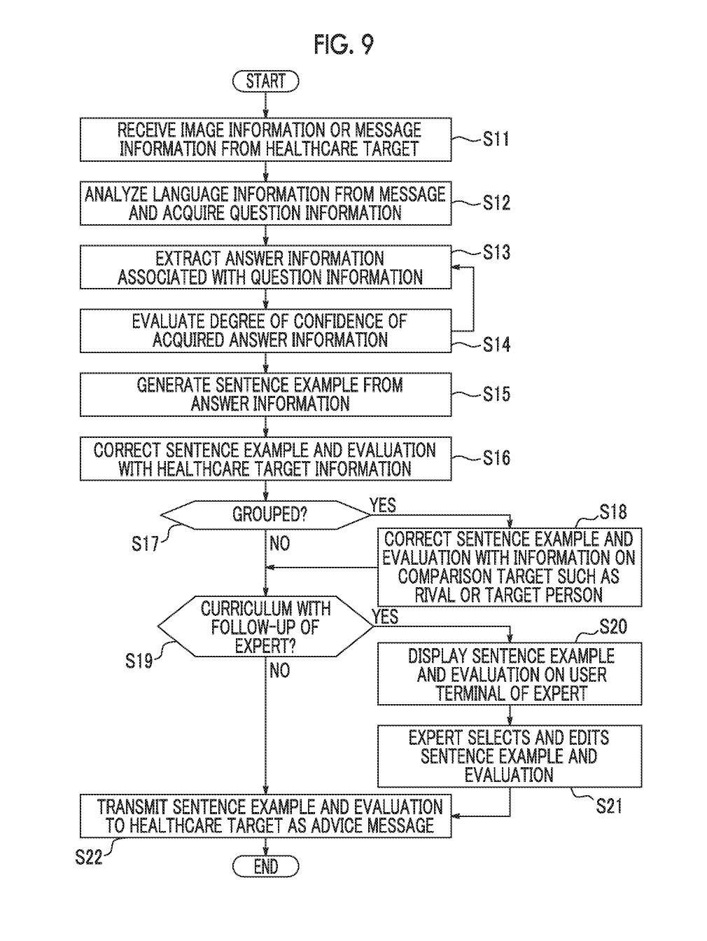

The operation of the healthcare server 100 will be described with reference to FIG. 9.

FIG. 9 is a flowchart illustrating an operation of the healthcare server 100.

The reception unit 110 receives image information or message information transmitted from the user terminal 200 of the healthcare target (step S11). The reception unit 110 transmits the received image information or the received message information to the analysis unit 120.

The analysis unit 120 analyzes language information from the received image information or the received message information and acquires question information (step S12). For example, as illustrated in FIG. 8A, in a case in which message information inquiring a recommended task from the healthcare target, such as “What is recommended to solve the lack of exercise”, is received, natural language is processed to be decomposed into morphemes such as “What/is/recommended/to/solve/the/lack/of/exercise” as the language information as illustrated in FIG. 8B, and respective parts of speech are determined. For example, as illustrated in FIG. 8C, the question information is searched for from the question information stored in the storage unit 160 using, as search keys, information such as 20 years of age, a height of 170 cm, and a weight of 60 kg as the decomposed and determined language information and the healthcare target information of the target, and the question information is acquired as illustrated in FIG. 8D. The acquired question information is delivered to the generation unit 130.

The generation unit 130, for example, extracts answer information associated with the acquired question information from the question information, generates a hypothesis from the extracted answer information, and verifies the answer information based on the ground supporting the hypothesis, as illustrated in FIG. 8E (S13). Further, the generation unit 130, for example, generates the sentence example from the verified answer information (step S15), and delivers the generated sentence example and the degree of confidence evaluated by the evaluation unit 140 together to the correction unit 150, as illustrated in FIG. 8F. In FIG. 8F, a radio button for selecting a recommended task advised in the sentence example is provided, and the behavior selection information is acquired by a designation of the radio button. However, the present invention is not limited to the radio button and, for example, the evaluation unit 140 may acquire the behavior selection information from reply message information of the healthcare target, which is message information such as “I would like to stretch among the recommended tasks.”, and performs the determination.

The evaluation unit 140 evaluates the degree of confidence of the answer information extracted by the generation unit 130 based on, for example, grounds verified by the generation unit 130 and a previous evaluation of the answer information (step S14). The evaluated degree of confidence is delivered to return to the generation unit 130.

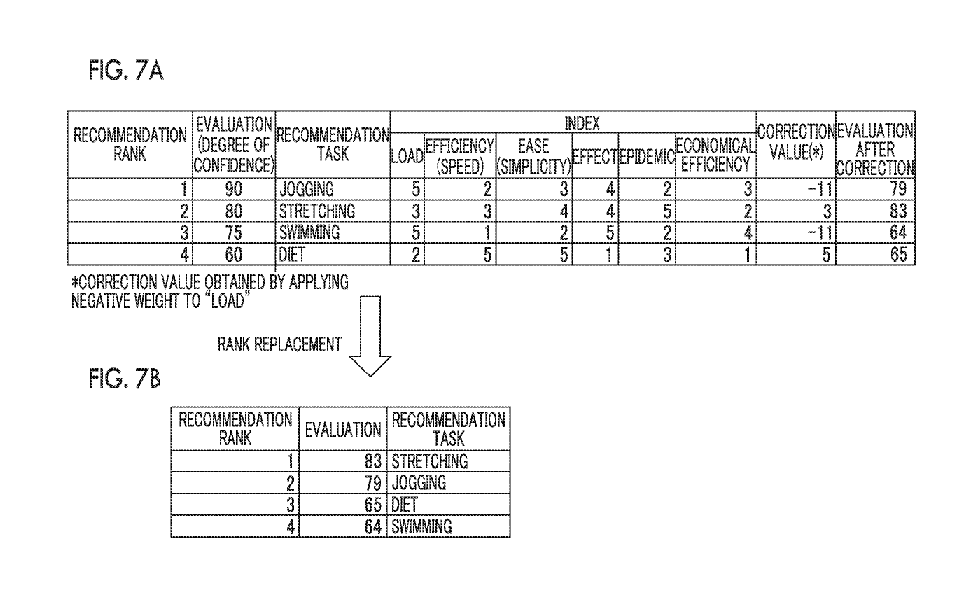

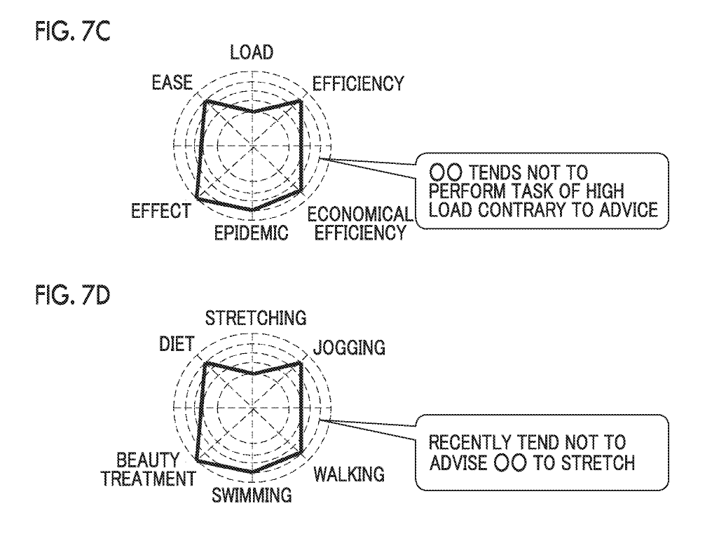

The correction unit 150 corrects the sentence example and the evaluation based on the healthcare target information (step 16). Specifically, as an example, as illustrated in FIG. 7A, in a case in which the degree of confidence of the extracted answer information is evaluated in an order of jogging, stretching, swimming, and diet, recommendation ranking is once set in an order of the evaluation. Here, for example, in a case in which a behavior tendency such as as “a task of a high load tends not to be performed contrary to the advice” in a chart showing a tendency value of the behavior of the relevant healthcare target as illustrated in FIG. 7C is attached to a “load” of an index of each recommended task, the recommended content does not necessarily fit to the healthcare target.

Therefore, in a case in which there is the relevant tendency, it is possible to apply a negative weight to the index of “load” and then calculate a sum of the indexes as a correction value, and correct the degree of confidence through, for example, a process of applying the correction value to the degree of confidence. A method for the correction is not limited to this calculation method and, for example, a correlation coefficient between two values including the feature value of the living body or the tendency value of the behavior and the value of any one of the indexes may be obtained from a covariance and a standard deviation of the two values, and the degree of confidence may be corrected with the correlation coefficient. Based on the evaluation after the correction, the ranking of recommendation is replaced as illustrated in FIG. 7B, and accordingly, it is possible to advise the recommended task further fitted to the healthcare target. In the correction, the degree of confidence may be corrected from the history and the frequency of use of the task in the sentence example as illustrated in FIG. 7D, as well as the tendency of the healthcare target to the task. The corrected sentence example and evaluation are delivered to return to the evaluation unit 140.

The evaluation unit 140 determines whether or not the healthcare target is grouped. In a case that the healthcare target is grouped (YES in step S17), the group evaluation unit 140 determines another healthcare target in a group to which the same, similar, or opposing illustration is transmitted within a predetermined time as a comparison target who is a rival or a target person, and delivers the determination to the correction unit 150.

The correction unit 150 corrects the sentence example and the evaluation with information on the determined comparison target (step S18). Specifically, for example, the correction unit 150 can specify a name of the comparison target in the sentence example, and add a sentence such as “Mr./Ms. ΔΔ (name of comparison target) also performs jogging recommended to Mr./Ms. ∘∘ (healthcare target) and makes an effort!” for correction. The correction unit 150 delivers the determined and corrected sentence example and evaluation to the transmission unit 170.

The transmission unit 170 determines whether or not a curriculum is a curriculum with a follow-up of an expert from the curriculum information. In a case in which the curriculum is a curriculum with a follow-up (YES in step S19), the generated and corrected sentence example and evaluation are displayed and output on the display unit 310 of the user terminal 300 of the expert (step S20).

For the sentence example displayed and output on the display unit 310, the expert selects the sentence example to be transmitted to the healthcare target, and edits the selected sentence example and evaluation, if necessary (step S21). The display unit 310 delivers the selected and edited sentence example and evaluation to the transmission unit 170.

The transmission unit 170 transmits the delivered sentence example and evaluation to the user terminal 200 (step S22).

The above is a description of the operation of the healthcare server 100.

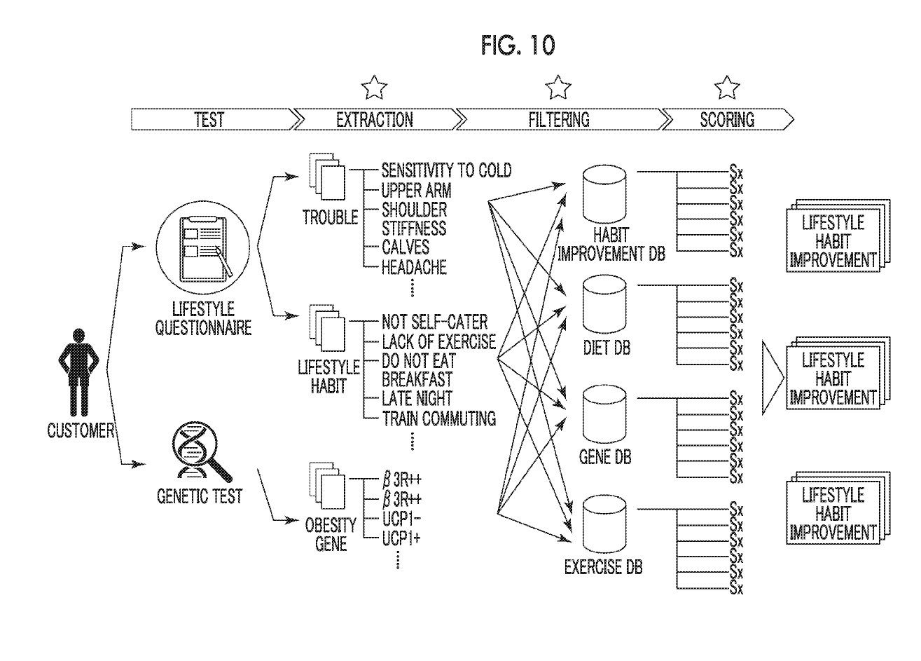

As illustrated in FIG. 10, the healthcare server 100 can perform cross-analysis based on a lifestyle questionnaire result of the healthcare target and a test result of a genetic test of the healthcare target, and achieve standardization and efficiency of creation of a report for performing guidance aiming at improvement of lifestyle, eating habit, or exercise habit.

Specifically, the healthcare server 100 extracts a trouble about the health of the healthcare target and a feature of the lifestyle from the lifestyle questionnaire result of the healthcare target, stores the extracted content and a result of the genetic test of the healthcare target in the storage unit 160, filters and scores the stored data to perform the cross-analysis, and automatically performs creation of the report from a result of the analysis to achieve standardization and efficiency of the creation. The extraction and the cross-analysis are performed by the analysis unit 120, and the creation of the report is performed by the evaluation unit 140.

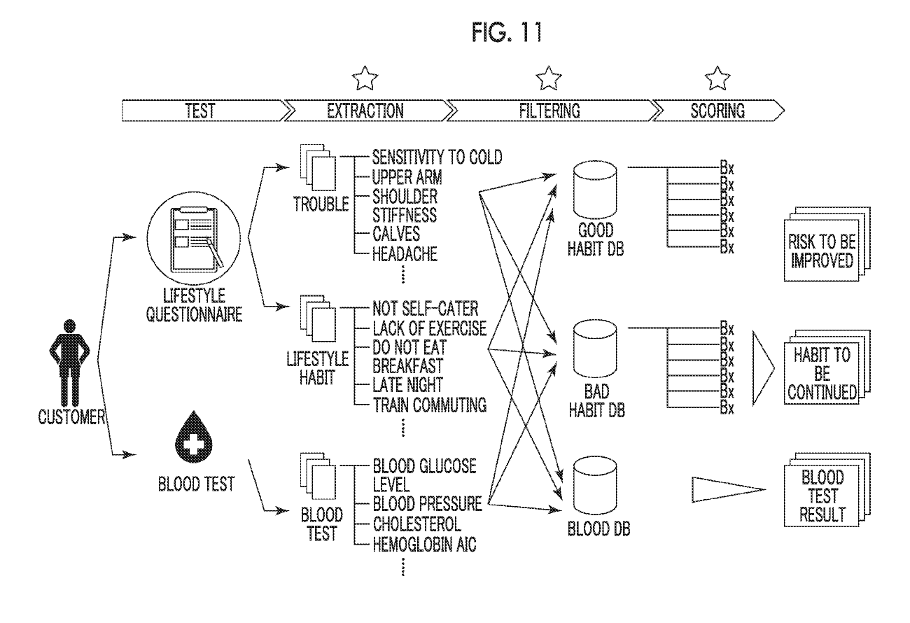

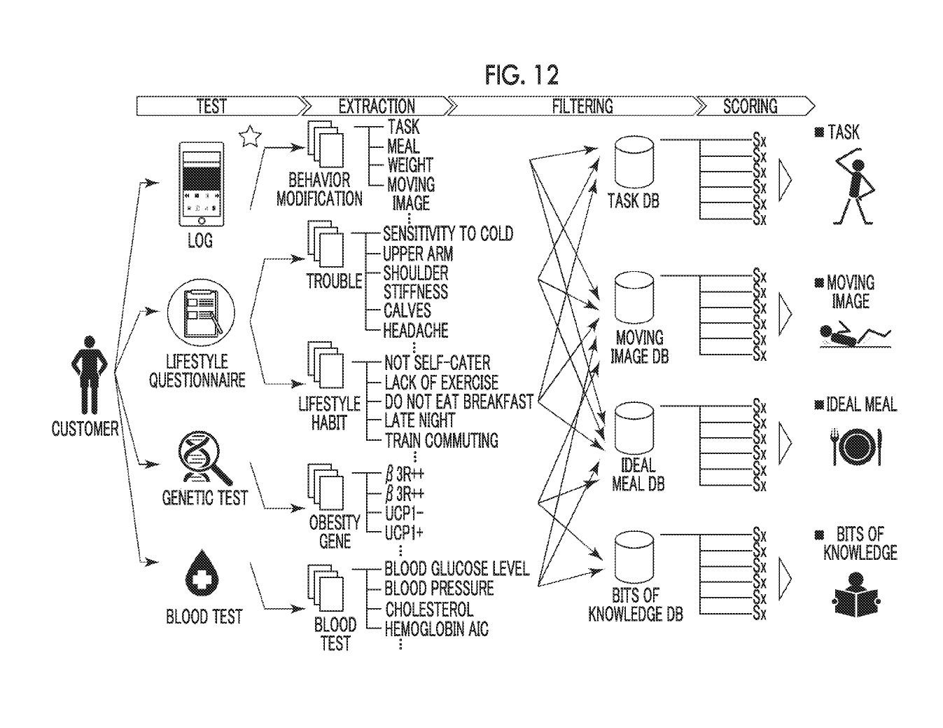

Further, as illustrated in FIG. 11, the healthcare server 100 can perform cross-analysis based on the lifestyle questionnaire result of the healthcare target and a test result of a blood test of the healthcare target, and achieve standardization and efficiency of the report creation for performing guidance aiming at improvement of habit to be improved and the continuation of habit to be continued.

Specifically, the healthcare server 100 extracts a lifestyle related to blood of the healthcare target from the lifestyle questionnaire result of the healthcare target, stores the extracted content and the result of the blood test of the healthcare target in the storage unit 160, filters and scores the stored data to perform the cross-analysis, and automatically performs the creation of the report from the analysis result to achieve standardization and efficiency of the creation. The extraction and the cross-analysis are performed by the analysis unit 120, and the creation of the report is performed by the evaluation unit 140.

Further, as illustrated in FIG. 12, the healthcare server 100 can perform cross-analysis based on a previously performed action history (hereinafter referred to as a “log”) of the healthcare target, the lifestyle questionnaire result, the genetic test result, and the blood test result, and perform content distribution aiming at providing a task effective in diet and lifestyle activity action performed by the healthcare target, training and fitness videos, ideal diet, and health knowledge to achieve reduction in a load of the guidance by the expert.

Specifically, the healthcare server extracts behavior modification and trouble of the healthcare target from the log, the lifestyle questionnaire result, and the lifestyle questionnaire result of the healthcare target, stores the extracted content, and the genetic test result and the blood test result of the healthcare target in the storage unit 160, filters and scores the stored data to perform the cross-analysis, and performs content distribution from the analysis result to achieve reduction in a load of the guidance by the expert. The extraction and the cross-analysis are performed by the analysis unit 120, and the content distribution is performed by the transmission unit 170.

<Others>

Although the health guidance service has been described as the service according to the present invention, the present invention can also be used in business other than the relevant business. In particular, the present invention can be used in business using an approach to psychology and spirit of people (for example, business for providing advice to increase motivation of people), or business such as welfare (for example, a case in which an expert remotely provides advice for welfare of a local community) and education.

1. A healthcare server connected to a terminal over a network, the healthcare server comprising:
a storage unit that stores healthcare target information of a healthcare target having the terminal, question information and answer information;
a reception unit that receives image information or message information transmitted from the terminal;
an analysis unit that analyzes language information based on the received message information and acquires the question information from the analyzed language information;
a generation unit that extracts the answer information corresponding to the acquired question information and generates a sentence example based on the extracted answer information;
an evaluation unit that evaluates the extracted answer information with a degree of confidence indicating the certainty of the answer information;
a correction unit that corrects the sentence example and the evaluation based on the healthcare target information; and
a transmission unit that transmits the corrected sentence example and evaluation to the terminal.

2. The healthcare server according to claim 1,
wherein the healthcare server is connected to the terminal over the network, and
the corrected sentence example and evaluation are displayed on and output to a display unit of the terminal.

3. The healthcare server according to claim 2,
wherein the transmission unit transmits advice information including a sentence example and an evaluation selected or selected and edited on the display unit by an expert to the terminal.

4. The healthcare server according to claim 1,
wherein the evaluation unit determines whether the degree of confidence of the evaluation is higher or lower than a certain level, and selects either correction of the sentence example or generation of an alert message and notification of the alert message to the expert, based on a result of the determination,
the correction unit corrects the sentence example based on the determination result and the answer information for avoidance in a case in which the evaluation unit selects the correction of the sentence example, and
the transmission unit notifies a terminal of the expert of the alert message in a case in which the evaluation unit selects the notification of the alert message to the expert.

5. The healthcare server according to claim 1,
wherein the reception unit receives sentence example selection information of the expert, and behavior selection information, behavior execution information and biological log information of the healthcare target from the terminal, and
the evaluation unit performs a combination based on the sentence example selection information, the behavior selection information, the behavior execution information, and the biological log information that have been received or a time stamp of the information, and evaluates answer information associated with the sentence example selection information, the behavior selection information, the behavior execution information, and the biological log information that have been combined.

6. The healthcare server according to claim 1,
wherein the image information is captured by the terminal, and
the analysis unit calculates a feature of the captured image information, and analyzes language information based on the feature and the question information.

7. The healthcare server according to claim 1, further comprising:
a calculation unit that calculates a use frequency of answer information of each healthcare target,
wherein the storage unit stores a past use history and a past use frequency of the answer information of the healthcare target, as use history information, and
the correction unit corrects the sentence example based on the use history information.

8. The healthcare server according to claim 1,
wherein the reception unit receives image information or message information transmitted from a plurality of terminals grouped in advance,
the evaluation unit specifies a terminal in the group to which a sentence example same as, similar to, or opposite to a sentence example transmitted to the terminal is transmitted within a predetermined time, and determines a healthcare target holding the specified terminal as a comparison target, and
the correction unit also corrects the sentence example and the evaluation based on information on the comparison target.

9. A control method for a healthcare server connected to a terminal over a network, the control method comprising:
storing healthcare target information of a healthcare target having the terminal, question information, and answer information;
receiving image information or message information transmitted from the terminal;
analyzing language information based on the received message information, and acquiring the question information from the analyzed language information;
extracting the answer information corresponding to the acquired question information and generating a sentence example based on the extracted answer information;
evaluating the extracted answer information with a degree of confidence indicating the certainty of the answer information;
correcting the sentence example and the evaluation based on the healthcare target information; and
transmitting the corrected sentence example and evaluation to the terminal.

10. A non-transitory computer readable medium storing a healthcare program causing a computer to execute control of a healthcare server connected to a terminal over a network, the healthcare program comprising:
storing healthcare target information of a healthcare target having the terminal, question information, and answer information;
receiving image information or message information transmitted from the terminal;
analyzing language information based on the received message information, and acquiring the question information from the analyzed language information;
extracting the answer information corresponding to the acquired question information and generating a sentence example based on the extracted answer information;
evaluating the extracted answer information with a degree of confidence indicating the certainty of the answer information;
correcting the sentence example and the evaluation based on the healthcare target information; and
transmitting the corrected sentence example and evaluation to the terminal.
